(19) United States
(12) Patent Application Publication
(10) Pub. No.: US 2024/0287328 A1
(43) Pub. Date: Aug. 29, 2024

(54) COMPOSITION FOR PAINTING/COATING APPLICATIONS CONTAINING A PARTICULAR COPOLYMER DISPERSANT WITH AT LEAST ONE b-CARBOXYETHYL ACRYLATE MONOMER

(71) Applicant: SPECIALTY OPERATIONS FRANCE, Lyon (FR)

(72) Inventors: Lichang Zhou, Lawrenceville, NJ (US); Wojciech Bzducha, Courbevoie (FR); David James Wilson, Coye-La-Forêt (FR); Brian Vest, Levittown, PA (US)

(73) Assignee: SPECIALTY OPERATIONS FRANCE, Lyon (FR)

(21) Appl. No.: 18/564,406

(22) PCT Filed: May 18, 2022
(86) PCT No.: PCT/EP2022/063493

§ 371 Date: Nov. 27, 2023

Related U.S. Application Data
(60) Provisional application No. 63/193,197, filed on May 26, 2021.

(51) Int. Cl. C09D 7/45; C08F 220/28; C08L 33/10; C09D 7/65; C09D 11/322; C09D 11/326; C09K 23/34

(52) U.S. Cl. CPC C09D 7/45; C08F 220/286; C08L 33/10; C09D 7/65; C09D 11/322; C09D 11/326; C09K 23/34

(57) ABSTRACT

The present invention relates to compositions for painting and/or coating containing particular copolymer dispersants. The invention also relates to the use of a copolymer according to the invention as a dispersant in a painting, coating and/or ink composition.

The invention also relates to the use of a copolymer according to the invention as a dispersant in a painting, coating and/or ink composition.

Paints and coatings, typically, are compositions containing pigments, dispersants, carrier/solvents, and other components, which are used to add color, via pigments.

Pigments are typically organic or inorganic dry powders that incorporate a mixture of primary particles, aggregates and agglomerates, which should be wetted in a carrier fluid or solvent.

Dispersants are widely used in coating compositions in order to disperse said inorganic or organic pigments. Dispersants can be divided to small molecules and polymers with varied chemistries. Most widely used polymeric dispersants are based on acrylic acid homopolymer or copolymers. The current state-of-the art systems use polymeric dispersants specific for the system used, or through dispersants that can be used in both solvent-borne and water-borne systems (hereafter referred to as universal dispersants), but that are used with organic solvents (like acetates or ketones) that can be miscible in both types of paints. These systems with a high level of organic solvents added contribute significantly to a paint's overall VOC (volatile organic compounds) content, while regulations require formulators to reduce the VOC contents in new paints to a near zero level.

In addition, pigment slurries especially aqueous slurries containing such dispersants have very limited shelf lives ranging from a couple of weeks to a few months. This is because these dispersants do not provide sufficient long-lasting stabilization, which often times causes the settling of pigment.

Thus, there is a continuous need for providing improved compositions for painting and coating, and in particular for providing robust and efficient dispersant polymers which improve the physical stability of dispersions of pigments, while limiting the content of organic solvents in the composition.

These objectives are achieved with the present invention, a subject-matter of which is a composition for painting and/or coating comprising:
(i) at least one copolymer obtainable by radical polymerization of:
at least the following monomers:
a) acrylic acid,
b) at least one β-carboxyethyl (meth)acrylate monomer,
c) at least one alkyl (meth)acrylate monomer, said alkyl radical comprising from 1 to 12 carbon atoms,
d) at least one hydrophobic non-acrylic monomer, and
e) at least one (C₁-C₁₂)alkyloxy polyethylene glycol (meth)acrylate monomer,
in the presence of a free-radical polymerization initiator; and
(ii) at least one pigment; and
(iii) optionally, at least one water-based polymer.

The compositions according to the invention present good intrinsic physicochemical properties.

It has been noted that the compositions according to the invention guarantee a good suspensibility of the pigments, even when the concentration of the latter is high.

The compositions according to the invention present a high storage stability over time.

It has been also noted that the compositions according to the invention have a good viscosity and a good dispersion of pigments, which allows easier application thereof onto various materials.

Another subject-matter of the invention is the use of copolymer (i) as described hereafter, as a dispersant in a painting and/or coating composition comprising at least one pigment.

A subject-matter of the invention is also a method for treating a material, by applying the composition according to the invention onto the surface of said material.

Another subject-matter of the invention is the use of the copolymer (i) as described hereafter, as a dispersant in an ink composition comprising at least one pigment.

Other characteristics, aspects and advantages of the invention will emerge even more clearly on reading the description and the example that follows.

In the present description, and unless otherwise indicated:
the expression “at least one” is equivalent to the expression “one or more” and can be replaced therewith;
the expression “between” is equivalent to the expression “ranging from” and can be replaced therewith, and implies that the limits are included;
for the purposes of the present invention, the expression “greater than” and respectively the expression “less than” are intended to mean an open range which is strictly greater, respectively strictly less, and therefore that the limits are not included.

The term “good storage stability” is intended to denote compositions which remain homogeneous (that is to say which exhibit substantially no, or limited, phase separation (sedimentation, syneresis, etc.)) over time, in particular which remain substantially homogeneous when stored for at least one week at 0° C., or for at least 2 weeks at 54° C. or at least 3 months at 45° C.

The term “good viscosity” or “flowable” is intended to denote compositions exhibiting “good flowability”, that is to say having a viscosity allowing good application of the painting and/or coating compositions onto the surface of a material.

The term “suitable dispersion” or “good dispersion” is intended to mean a dispersion after dilution in water which is homogeneous (that is to say which exhibits substantially no phase separation. (sedimentation, syneresis, etc.)) over time, in particular which remains substantially homogeneous when stored for 30 minutes in a water bath thermostatically controlled at 30° C., preferably for 2 hours in a water bath thermostatically controlled at 30° C. and ideally for 24 hours in a water bath thermostatically controlled at 30° C. Such a dispersion must in particular make it possible to ensure good properties of use of the dispersed compounds.

### The Copolymer:

The composition according to the invention comprises at least one copolymer (i) obtainable by radical polymerization of:
at least the following monomers:
a) acrylic acid,
b) at least one β-carboxyethyl (meth)acrylate monomer,
c) at least one alkyl (meth)acrylate monomer, said alkyl radical comprising from 1 to 12 carbon atoms,
d) at least one hydrophobic non-acrylic monomer, and
e) at least one (C₁-C₁₂)alkyloxy polyethylene glycol (meth)acrylate monomer,
in the presence of a free-radical polymerization initiator.

Preferably, the copolymer (i) comprises from 0.1 to 15 mol. % of units from acrylic acid a); more preferentially from 0.5 to 10 mol. %; and even more preferentially from 1 to 8 mol. %.

Preferably, the β-carboxyethyl (meth)acrylate monomer(s) b) are of the following formula (I):

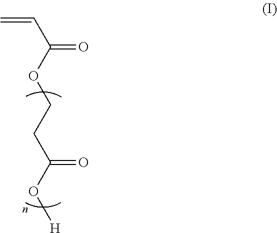

wherein n is an integer ranging from 1 to 5.

The monomer b) has been described for example in WO 2012/072911.

In a preferred embodiment, the at least one β-carboxyethyl (meth)acrylate monomer b) is a mixture of different β-carboxyethyl (meth)acrylate monomers of the above formula (I) with n ranging from 1 to 5.

Preferably, the copolymer (i) comprises from 1 to 35 mol. % of units from β-carboxyethyl (meth)acrylate b); more preferentially from 5 to 30 mol. %; and even more preferentially from 6 to 25 mol. %.

Preferably, the alkyl (meth)acrylate monomer(s) c) with an alkyl radical comprising from 1 to 12 carbon atoms are chosen from (C₁-C₁₂)alkyl acrylates.

More preferentially, the (C₁-C₁₂)alkyl (meth)acrylate monomer(s) c) are chosen from (C₄-C₁₀)alkyl acrylates; and even more preferentially from (C₆-C₈)alkyl acrylates.

According to a particularly preferred embodiment, the (C₁-C₁₂)alkyl (meth)acrylate monomer c) is 2-ethylhexyl acrylate.

Advantageously, the alkyl (meth)acrylate monomer(s) c) with an alkyl radical comprising from 1 to 12 carbon atoms are not polyoxyalkylenated, and more particularly the alkyl (meth)acrylate monomer(s) c) are not polyoxyethylenated nor polyoxypropylenated.

It is understood that the alkyl (meth)acrylate monomer(s) c) are different from the β-carboxyethyl (meth)acrylate monomer(s) b) according to the invention.

Preferably, the copolymer (i) comprises from 5 to 40 mol. % of units from alkyl (meth)acrylate c); more preferentially from 10 to 30 mol. %; and even more preferentially from 15 to 25 mol. %.

The hydrophobic non-acrylic monomer(s) d) may be selected from any non-acrylic monomer which is water insoluble. More particularly, the solubility of these monomers d) is less than 0.5% in water at 25° C. and at atmospheric pressure (1.013×10⁵ Pa).

For the purpose of the invention, the term “non-acrylic monomer” is intended to mean a monomer which does not contain any acrylic acid, acrylate, methacrylic acid and/or methacrylate moiety.

Preferably, the hydrophobic non-acrylic monomer(s) d) may be chosen from:
vinylaromatic monomers such as styrene, styrenes substituted with one or more C₁-C₆ alkyl groups, vinylnaphthalenes, vinylnaphthalenes substituted with one or more C₁-C₆ alkyl groups, and vinyltoluenes,
vinyl acetate,
vinyl esters of branched or unbranched saturated monocarboxylic acids containing from 1 to 12 carbon atoms, for instance vinyl propionate, vinyl “Versatate” (registered brand name for branched C₉-C₁₁ acid esters) and in particular for the vinyl neodecanoate known as Veova 10, vinyl pivalate, vinyl butyrate, vinyl 2-ethylhexylhexanoate or vinyl laurate;
mono- or diesters of unsaturated dicarboxylic acids containing from 4 to 6 carbon atoms with alkanols containing 1 to 10 carbon atoms, for instance methyl, ethyl, butyl or ethylhexyl maleate or fumarate; and
α-olefins containing from 6 to 20 carbon atoms and preferably from 8 to 14 carbon atoms, such as those available from Chevron Phillips under the tradename AlphaPlus.

More preferentially, the hydrophobic non-acrylic monomer(s) d) are chosen from vinyl aromatic monomers; even more preferentially from styrene, styrenes substituted with one or more C₁-C₆ alkyl groups, vinylnaphthalenes, vinylnaphthalenes substituted with one or more C₁-C₆ alkyl groups, and mixtures thereof.

Even better, the hydrophobic non-acrylic monomer d) is styrene.

Preferably, the copolymer (i) comprises from 30 to 60 mol. % of units from hydrophobic non-acrylic monomer d); more preferentially from 35 to 50 mol. %; and even more preferentially from 40 to 45 mol. %.

Preferably, the (C₁-C₁₂)alkyloxy polyethylene glycol (meth)acrylate monomer(s) e) are (C₁-C₄)alkyloxy polyethylene glycol (meth)acrylate monomer(s).

More preferentially, the (C₁-C₁₂)alkyloxy polyethylene glycol (meth)acrylate monomer(s) e) are methoxy polyethylene glycol (meth)acrylate monomer(s) (MPEGMA).

According to a preferred embodiment of the invention, the (C₁-C₁₂)alkyloxy polyethylene glycol (meth)acrylate monomer(s) e) are of the following formula (II):

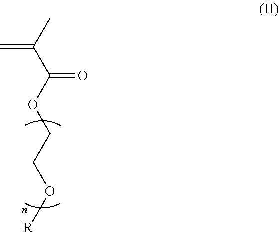

wherein n is an integer ranging from 3 to 30 and R denotes an alkyl group, linear or branched, containing from 1 to 12 carbon atoms.

Preferably, the number n of ethylene glycol unit of the (C₁-C₁₂)alkyloxy polyethylene glycol (meth)acrylate monomer e) ranges from 10 to 20.

More preferentially, the (C₁-C₁₂)alkyloxy polyethylene glycol (meth)acrylate monomer(s) e) are (C₁-C₄)alkyloxy polyethylene glycol (meth)acrylate monomer(s) of formula (II) above, wherein R denotes an alkyl group, linear or branched, containing from 1 to 4 carbon atoms.

Even more preferentially, the (C₁-C₁₂)alkyloxy polyethylene glycol (meth)acrylate monomer(s) e) are methoxy polyethylene glycol (meth)acrylate monomer(s) of formula (II) above, wherein R denotes a methyl.

Preferably, the copolymer (i) comprises from 1 to 30 mol. % of units from (C₁-C₁₂)alkyloxy polyethylene glycol (meth)acrylate e); better from 5 to 25 mol. %; and even better from 10 to 20 mol. %.

More preferentially, the copolymer (i) comprises from 1 to 30 mol. % of units from (C₁-C₄)alkyloxy polyethylene glycol (meth)acrylate e); better from 5 to 25 mol. %; and even better from 10 to 20 mol. %.

Even more preferentially, the copolymer (i) comprises from 1 to 30 mol. % of units from methoxy polyethylene glycol (meth)acrylate e); better from 5 to 25 mol. %; and even better from 10 to 20 mol. %.

According to a particular embodiment of the invention, the monomers used of the polymerization of said copolymer (i) further include a methacrylic acid monomer f).

In other words, according to this embodiment, the copolymer (i) is obtainable by radical polymerization of:
at least the following monomers:
a) acrylic acid,
b) at least one β-carboxyethyl (meth)acrylate monomer,
c) at least one alkyl (meth)acrylate monomer, said alkyl radical comprising from 1 to 12 carbon atoms,
d) at least one hydrophobic non-acrylic monomer,
e) at least one (C₁-C₁₂)alkyloxy polyethylene glycol (meth)acrylate monomer, and
f) methacrylic acid,
in the presence of a free-radical polymerization initiator.

More preferentially according to this embodiment, the copolymer (i) comprises from 0.1 to 20 mol. % of units from methacrylic acid f), and even more preferentially from 5 to 20 mol. %.

Preferably, the copolymer (i) has a weight average molecular weight (Mw) less than or equal to 20,000 g/mol.

In particular, the copolymer (i) has a weight average molecular weight (Mw) ranging from 2,000 to 20,000 g/mol, and more particularly from 8,000 to 20,000 g/mol.

More preferentially, the copolymer (i) has a weight average molecular weight (Mw) less than or equal to 17,000 g/mol; and even more preferentially ranging from 10,000 to 17,000 g/mol.

Preferably, the copolymer (i) has a number average molecular weight (Mn) less than or equal to 10,000.

In particular, the copolymer (i) has a number average molecular weight (Mn) ranging from 4,000 to 10,000.

More preferentially, the copolymer (i) has a number average molecular weight (Mn) less than or equal to 8,000 g/mol; and even more preferentially ranging from 5,000 to 8,000 g/mol.

The polydispersity index (PDI) is used as a measure of broadness of the molecular weight distribution of a polymer. The larger the PDI, the broader the distribution. In a manner known per se, the PDI index of a polymer is calculated as the ratio of weight average (Mw) by number average (Mn) molecular weight, in accordance with the following formula:

$$P D I = Mw / Mn$$

Preferably, the polydispersity index of copolymer (i) as described previously ranges from 1 to 3,5; more preferentially from 1.5 to 3; and even more preferentially from 2 to 2.5.

According to a preferred embodiment of the invention, the copolymer (i) is free of unit from strong acid derivatives of (meth)acrylic acid monomers.

More preferentially according to this embodiment, the copolymer (i) is free of units from 2-acrylamido-2-methylpropane sulfonic acid, sodium methallyl sulphonate, sodium styrene sulphonate and/or (meth)acrylic acid isethionate.

For the purpose of the invention, the term “free of unit from strong acid derivatives of (meth)acrylic acid monomers” is intended to mean that the copolymer (i) contains less than 0.1 mol. % of units resulting from the radical polymerization of at least strong acid derivatives of (meth)acrylic acid monomers, and more preferentially less than 0.01 mol. %, and even more preferentially the copolymer (i) does not contain at all (0% mol) units resulting from the radical polymerization of at least strong acid derivatives of (meth)acrylic acid monomers.

More preferentially according to this embodiment, the copolymer (i) contains less than 0.1 mol. %, and even more preferentially less than 0.01 mol. %, of units from 2-acrylamido-2-methylpropane sulfonic acid, sodium methallyl sulphonate, sodium styrene sulphonate and/or (meth)acrylic acid isethionate monomers. Even more preferentially the copolymer (i) does not contain at all (0% mol) units resulting from 2-acrylamido-2-methylpropane sulfonic acid, sodium methallyl sulphonate, sodium styrene sulphonate and/or (meth)acrylic acid isethionate monomers.

According to a particularly preferred embodiment of the invention, the copolymer (i) is obtainable by radical polymerization of:
the following monomers only:
a) acrylic acid,
b) at least one β-carboxyethyl (meth)acrylate monomer,
c) at least one alkyl (meth)acrylate monomer, said alkyl radical comprising from 1 to 12 carbon atoms,
d) at least one hydrophobic non-acrylic monomer, and
e) at least one (C₁-C₁₂)alkyloxy polyethylene glycol (meth)acrylate monomer,
f) optionally methacrylic acid monomer,
in the presence of a free-radical polymerization initiator.

For the purpose of the invention, the term “of the following monomers only” is intended to mean that the copolymer (i) only comprises units obtained from the monomers a) to f) as described above. In other word, according to this embodiment, the copolymer (i) does not contain units from monomers other than monomers a) to f) as described above.

It is understood that the monomers a) to f) are different from each other.

The copolymers (i) used in the present invention are obtainable by radical polymerization of at least monomers a) to e) as described previously in the presence of a free-radical polymerization initiator.

The free-radical polymerization initiator which can be used for the radical polymerization may be chosen from any source of free radicals which is known per se as being suitable for polymerization processes.

The radical polymerization initiator may, for example, be selected from the following initiators:
peroxyoctoate, t-butyl peroxyneodecanoate, t-butyl peroxyisobutyrate, lauroyl peroxide, t-amyl peroxypivalate, t-butyl peroxypivalate, dicumyl peroxide, benzoyl peroxide, potassium persulfate, ammonium persulfate,
azo compounds such as: 2-2′-azobis(isobutyronitrile), 2,2′-azobis(2-butanenitrile), 4,4′-azobis(4-pentanoic acid), 1,1′-azobis(cyclohexanecarbonitrile), 2-(t-butylazo)-2-cyanopropane, 2,2′-azobis[2-methyl-N-(1,1)-bis(hydroxymethyl)-2-hydroxyethyl]propionamide, 2,2′-azobis(2-methyl-N-hydroxyethyl]propionamide, 2,2′-azobis(N,N′-dimethyleneisobutyramidine)dichloride, 2,2′-azobis(2-amidinopropane)dichloride, 2,2′-azobis(N,N′-dimethyleneisobutyramide), 2,2′-azobis(2-methyl-N-[1,1-bis(hydroxymethyl)-2-hydroxyethyl]propionamide), 2,2′-azobis(2-methyl-N-[1,1-bis(hydroxymethyl)ethyl]propionamide), 2,2′-azobis[2-methyl-N-(2-hydroxyethyl)propionamide] or 2,2′-azobis(isobutyramide)dihydrate,
redox systems comprising combinations such as:
mixtures of hydrogen peroxide, alkyl peroxide, peresters, percarbonates and the like and any iron salts, titanous salts, zinc formaldehyde sulfoxylate or sodium formaldehyde sulfoxylate, and reducing sugars, alkali metal or ammonium persulfates, perborate or perchlorate in combination with an alkali metal bisulfite, such as sodium metabisulfite, and reducing sugars, and alkali metal persulfates in combination with an arylphosphinic acid, such as benzenephosphonic acid and the like, and reducing sugars.

According to one advantageous embodiment, use may be made of a radical initiator of redox type, which has the advantage of not requiring specific heating of the reaction medium (no thermal initiation). It is typically a mixture of at least one medium soluble oxidizing agent with at least one medium soluble reducing agent.

The oxidizing agent present in the redox system may be selected, for example, from peroxides such as: hydrogen peroxide, tert-butyl hydroperoxide, cumene hydroperoxide, t-butyl peroxyacetate, t-butyl peroxybenzoate, t-butyl peroxyoctoate, t-butyl peroxyneodecanoate, t-butyl peroxyisobutyrate, lauroyl peroxide, t-amyl peroxypivalate, t-butyl peroxypivalate, dicumyl peroxide, benzoyl peroxide, sodium persulfate, potassium persulfate, ammonium persulfate or potassium bromate.

The reducing agent present in the redox system may typically be selected from sodium formaldehyde sulfoxylate (in particular in dihydrate form, known under the name Rongalit, or in the form of an anhydrite), ascorbic acid, erythorbic acid, sulfites, bisulfites or metasulfites (in particular alkali metal sulfites, bisulfites or metasulfites), nitrilotrispropionamides, and tertiary amines and ethanolamines (which are preferably water-soluble).

Possible redox systems comprise combinations such as:
mixtures of water-soluble persulfates with water-soluble tertiary amines mixtures of water-soluble bromates (for example alkali metal bromates) with water-soluble sulfites (for example alkali metal sulfites),
mixtures of hydrogen peroxide, alkyl peroxide, peresters, percarbonates and the like and any iron salts, titanous salts, zinc formaldehyde sulfoxylate or sodium formaldehyde sulfoxylate, and reducing sugars, alkali metal or ammonium persulfates, perborate or perchlorate in combination with an alkali metal bisulfite, such as sodium metabisulfite, and reducing sugars, and alkali metal persulfates in combination with an arylphosphinic acid, such as benzenephosphonic acid and the like, and reducing sugars.

An advantageous redox system comprises (and preferably consists of) for example a combination of ammonium persulfate and sodium formaldehyde sulfoxylate.

Preferably, the copolymers (i) used in the present invention are obtainable by controlled radical polymerization of at least monomers a) to e) as described previously in the presence of a radical polymerization control agent and a free-radical polymerization initiator.

The free-radical polymerization initiator may be chosen from the free-radical polymerization initiators described above.

The radical polymerization control agents which can be used for the controlled radical polymerization may especially have the formula (III) below:

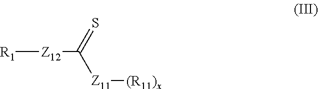

in which:
Z₁₁ represents C, N, O, S or P,
Z₁₂ represents S or P,
R₁₁ represents:
an optionally substituted alkyl, acyl, aryl, alkene or alkyne group (i), or
a saturated or unsaturated, optionally substituted or aromatic carbon-based ring (ii), or
a saturated or unsaturated, optionally substituted heterocycle (iii), these groups and rings (i), (ii) and (iii) possibly being substituted with substituted phenyl groups, substituted aromatic groups or groups: alkoxycarbonyl or aryloxycarbonyl (—COOR), carboxyl (—COOH), acyloxy (—O₂CR), carbamoyl (—CONR₂), cyano (—CN), alkylcarbonyl, alkylarylcarbonyl, arylcarbonyl, arylalkylcarbonyl, phthalimido, maleimido, succinimido, amidino, guanidino, hydroxyl (—OH), amino (—NR₂), halogen, allyl, epoxy, alkoxy (—OR), S-alkyl, S-aryl, groups of hydrophilic or ionic nature such as the alkali metal salts of carboxylic acids, the alkali metal salts of sulphonic acid, polyalkylene oxide (PEO or PPO) chains and cationic substituents (quaternary ammonium salts),
R representing an C₁-C₈ alkyl or aryl group,
x corresponds to the valency of Z₁₁, or alternatively x is 0, in which case Z₁₁ represents a phenyl, alkene or alkyne radical, optionally substituted with an optionally substituted alkyl; acyl; aryl; alkene or alkyne group; an optionally substituted, saturated, unsaturated, or aromatic, carbon-based ring; an optionally substituted, saturated or unsaturated heterocycle; alkoxycarbonyl or aryloxycarbonyl (—COOR); carboxyl (COOH); acyloxy (—O₂CR); carbamoyl (—CONR₂); cyano (—CN); alkylcarbonyl; alkylarylcarbonyl; arylcarbonyl; arylalkylcarbonyl; phthalimido; maleimido; succinimido; amidino; guanidino; hydroxyl (—OH); amino (—NR₂); halogen; allyl; epoxy; alkoxy (—OR), S-alkyl; S-aryl groups; groups of hydrophilic or ionic nature such as the alkali metal salts of carboxylic acids, the alkali metal salts of sulphonic acid, polyalkylene oxide (PEO or PPO) chains and cationic substituents (quaternary ammonium salts); and
R₁ represents:
an optionally substituted alkyl, acyl, aryl, aralkyl, alkene or alkyne group saturated or unsaturated, aromatic, optionally substituted carbocycle or heterocycle, or a polymer chain.

R₁, when substituted, may be substituted with optionally substituted phenyl groups, optionally substituted aromatic groups, saturated or unsaturated carbocycles, saturated or unsaturated heterocycles, or groups selected from the following: alkoxycarbonyl or aryloxycarbonyl (—COOR), carboxyl (—COOH), acyloxy (—O₂CR), carbamoyl (—CONR₂), cyano (—CN), alkylcarbonyl, alkylarylcarbonyl, arylcarbonyl, arylalkylcarbonyl, phthalimido, maleimido, succinimido, amidino, guanidino, hydroxyl (—OH), amino (—NR₂), halogen, perfluoroalkyl CₙF₂ₙ₊₁, allyl, epoxy, alkoxy (—OR), S-alkyl, S-aryl, groups of hydrophilic or ionic nature such as alkali metal salts of carboxylic acids, alkali metal salts of sulfonic acid, polyalkylene oxide chains (PEO, PPO), cationic substituents (quaternary ammonium salts), R representing an alkyl or aryl group, or a polymer chain.

According to one particular embodiment, R₁ is a substituted or unsubstituted, preferably substituted, alkyl group.

The optionally substituted alkyl, acyl, aryl, aralkyl or alkyne groups to which reference is made in the definition of formula (II) above generally contain 1 to 20 carbon atoms, preferably 1 to 12 and more preferentially 1 to 9 carbon atoms. They may be linear or branched. They may also be substituted with oxygen atoms, in particular in the form of esters or sulfur or nitrogen atoms.

Among the alkyl radicals, mention may be made especially of methyl, ethyl, propyl, butyl, pentyl, isopropyl, tert-butyl, pentyl, hexyl, octyl, decyl or dodecyl radicals.

For the purposes of the present description of formula (III), the alkyne groups are radicals generally containing from 2 to 10 carbon atoms, and contain at least one acetylenic unsaturation, such as the acetylenyl radical.

For the purposes of the present description of formula (III), the acyl groups are radicals generally containing from 1 to 20 carbon atoms with a carbonyl group. Among the aryl radicals which may be used according to the invention, mention may be made in particular of the phenyl radical, optionally substituted especially with a nitro or hydroxyl function.

Among the aralkyl radicals, mention may be made in particular of the benzyl or phenethyl radical, optionally substituted especially with a nitro or hydroxyl function.

When R₁ is a polymer chain, this polymer chain may be derived from a radical or ionic polymerization or derived from a polycondensation.

Advantageously, the radical polymerization control agent is a xanthate compound, for instance O-ethyl-S-(1-methoxycarbonyl ethyl) xanthate of formula (CH₃CH(CO₂CH₃))S(C═S)OCH₂CH₃.

A control agent that is particularly suited to the controlled radical polymerization is the compound sold by the company Solvay under the name Rhodixan®A1.

Preferably, the amount of copolymer(s) (i) in the composition according to the invention range from 0.001 to 70% by weight, more preferentially from 0.01 to 50% by weight; even more preferentially from 0.1 to 40% by weight; better from 0.5 to 35% by weight, relative to the total weight of the composition.

According to a particular embodiment of the invention, the amount of copolymer(s) (i) in the composition according to the invention range from 1 to 20% by weight, more preferentially from 1 to 10% by weight, relative to the total weight of the composition.

The present invention also relates to the use of the copolymer (i) as described previously, as a dispersant in a composition comprising at least one pigment.

### The Pigments

The composition according to the invention comprises at least one pigment.

By way of example, the pigments may be white or coloured, mineral and/or organic, and coated or uncoated.

Among the mineral pigments (i.e. non organic) that may be mentioned are metal oxides, in particular titanium dioxide, optionally surface-treated, zirconium oxide, zinc oxide or cerium oxide, and also iron oxide, titanium oxide or chromium oxide, manganese violet, ultramarine blue, ultramarine pink, chromium hydrate and ferric blue, and mixtures thereof.

In particular, for example: white pigments: titanium dioxide (C.I. Pigment White 6), zinc white, pigment grade zinc oxide; zinc sulphide, lithopone; Black pigments: iron oxide black (C.I. Pigment Black 11), iron manganese black, spinel black (C.I. Pigment Black 27); carbon black (C.I. Pigment Black 7); Chromatic pigments: chromium oxide, chromium oxide hydrate green; chrome green (C.I. Pigment Green 48); cobalt green (C.I. Pigment Green 50); ultramarine green; cobalt blue (C.I. Pigment Blue 28 and 36; C.I. Pigment Blue 72); ultramarine blue; manganese blue; ultramarine violet; cobalt violet; manganese violet; red iron oxide (C.I. Pigment Red 101); cadmium sulfoselenide (C.I. Pigment Red 108); cerium sulphide (C.I. Pigment Red 265); molybdate red (C.I. Pigment Red 104); ultramarine red; brown iron oxide (C.I. Pigment Brown 6 and 7), mixed brown, spinel phases and corundum phases (C.I. Pigment Brown 29, 31, 33, 34, 35, 37, 39 and 40), chromium titanium yellow (C.I. Pigment Brown 24), chrome orange; cerium sulphide (C.I. Pigment Orange 75); yellow iron oxide (C.I. Pigment Yellow 42); nickel titanium yellow (C.I. Pigment Yellow 53; C.I. Pigment Yellow 157, 158, 159, 160, 161, 162, 163, 164 and 189); chrome yellow 37 and 35); chrome yellow (C.I. Pigment Yellow 34); bismuth vanadate (C.I. Pigment Yellow 184).

Among the organic pigments that may be mentioned are pigments of D & C type and lakes based on cochineal carmine or on barium, strontium, calcium or aluminium, and mixtures thereof.

In particular, for example: Monoazo pigments: (C.I. Pigment Yellow 1, 3, 62, 65, 73, 74, 97, 120, 151, 154, 168, 181, 183 and 191, C.I. Pigment Brown 25; C.I. Pigment Orange 5, 13, 36, 38, 64 and 67; C.I. Pigment Red 1, 2, 3, 4, 5, 8, 9, 12, 17, 22, 23, 31, 48:1, 48:2, 48:3, 48:4, 49, 49:1, 51:1, 52:1, 52:2, 53, 53:1, 53:3, 57:1, 58:2, 58:4, 63, 112, 146, 148, 170, 175, 184, 185, 187, 188, 191:1, 208, 210, 245, 247 and 251; C.I. Pigment Violet 32); Diazo pigments: (C.I. Pigment Orange 16, 34, 44 and 72; C.I. Pigment Yellow 12, 13, 14, 16, 17, 81, 83, 106, 113, 126, 127, 155, 174, 176 and 188; Diazo condensation pigments: C.I. Pigment Yellow 93, 95 and 128; pigments: C.I. Pigment Red 144, 166, 214, 220, 221, 242 and 262; C.I. Pigment Brown 23 and 41); Anthanthrone pigments: (C.I. Pigment Red 168); Anthraquinone pigments: (C.I. Pigment Yellow 147, 177 and 199; C.I. Pigment Violet 31); Anthrapyrimidine pigments: (C.I. Pigment Yellow 108); Quinacridone pigments: (C.I. Pigment Orange 48 and 49; C.I. Pigment Red 122, 202, 206 and 209; C.I. Pigment Violet 19); Quinophthalone pigments: (C.I. Pigment Yellow 138); Diketopyrrolopyrrole pigments: (C.I. Pigment Orange 71, 73 and 81; C.I. Pigment Red 254, 255, 264, 270 and 272); Dioxazine pigments: (C.I. Pigment Violet 23 and 37; C.I. Pigment Blue 80; flavanthrone pigments: C.I. Pigment Yellow 24); Indanthrone pigments: (C.I. Pigment Blue 60 and 64); Isoindoline pigments: (C.I. Pigments Orange 61 and 69; C.I. Pigment Red 260; C.I. Pigment Yellow 139 and 185); Isoindolinone pigments: (C.I. Pigment Yellow 109, 110 and 173); Isoviolanthrene pigments: (C.I. Pigment Violet 31); Metal complex pigments: (C.I. Pigment Red 257; C.I. Pigment Yellow 117, 129, 150, 153 and 177; C.I. Pigment Green 8); Perinone pigments: (C.I. Pigment Orange 43; C.I. Pigment Red 194); Perylene pigments: (C.I. Pigment Black 31 and 32; C.I. Pigment Red 123, 149, 178, 179, 190 and 224; C.I. Pigment Violet 29); Phthalocyanine pigments: (C.I. Pigment Blue 15, 15:1, 15:2, 15:3, 15:4, 15:6 and 16; C.I. Pigment Green 7 and 36); Pyranthrone pigments: (C.I. Pigment Orange 51; C.I. Pigment Red 216); Pyrazoloquinazolone pigments: (C.I. Pigment Orange 67; C.I. Pigment Red 251); Thio indigo pigments: (C.I. Pigment Red 88 and 181; C.I. Pigment Violet 38); Triarylcarbonium pigments: (C.I. Pigment Blue 1, 61 and 62; C.I. Pigment Green 1; C.I. Pigment Red 81, 81:1 and 169; C.I. Pigment Violet 1, 2, 3 and 27; C.I. Pigment Black 1 (aniline black); C.I. Pigment Yellow 101 (aldazine yellow); C.I. Pigment Brown 22.

Preferably, the pigments are chosen from titanium dioxide, zinc oxide, carbon black, and mixtures thereof.

Generally, the mean particle sizes of the pigments range from about 0.01 to about 50 microns. Preferably, the TiO₂ particles used in the composition typically have a mean particle size of from 0.15 to 0.40 microns. The pigment can be added to the composition as a powder or in slurry form.

Preferably, the pigment(s) are present in the composition according to the invention in an amount ranging from 5 to 50% by weight, more preferentially from 10 to 40% by weight, relative to the total weight of the composition.

Preferably, the weight ratio of the total content of copolymer (i) to the total content of pigment(s) ranges from 0.1 to 5; more preferentially from 0.25 to 3; and even more preferentially from 1 to 3.

Advantageously, the composition according to the invention may further contain at least one pigment extender.

Preferably, the pigment extender is chosen from clays, talc, calcium carbonate, mica, aluminium oxide, silicon dioxide, silica, magnesium oxide, magnesium stearate, magnesium carbonate, barites, and mixtures thereof.

Preferably, the clay according to the invention is a naturally occurring sediment or sedimentary rock composed of one or more minerals and accessory compounds, the whole usually being rich in hydrated aluminum silicate, iron or magnesium, hydrated alumina, or iron oxide, predominating in particles of colloidal or near-colloidal size.

Example of clays are given in the book “Clay mineralogy, S. Caillere, S. Henin, M. Rautureau, 2nd edition 1982, Masson.”.

Clays may be of natural or synthetic origin. Among the clays that may be mentioned are kaolinite, illite, vermiculite, smectite, chlorite, hectorites, montmorillonites, bentonites.

### Water-Based Polymer

Optionally, the composition according to the invention may further contain at least one water-based polymer.

The term “water-based polymer” is intended to mean polymers that dissolve, disperse, or swell in water and, thus, modify the physical properties of aqueous systems in the form of gelation, thickening, or emulsification/stabilization.

Preferably, the water-based polymer is chosen from latex polymers, polyurethane polymers, mixtures thereof.

More preferentially, the composition according to the invention may further contain at least one latex polymer.

Advantageously, the latex polymer is derived from at least one monomer, for example acrylic monomers. The latex polymers used in the composition can be a pure acrylic, a styrene acrylic, a vinyl acrylic or an acrylated ethylene vinyl acetate copolymer and is more preferably a pure acrylic polymer.

The latex polymers are preferably derived from at least one acrylic monomer selected from the group consisting of acrylic acid, acrylic acid esters, methacrylic acid, and methacrylic acid esters. For example, the latex polymers can be a butyl acrylate/methyl methacrylate copolymer or a 2-ethylhexyl acrylate/methyl methacrylate copolymer.

Typically, the latex polymers are further derived from one or more monomers selected from the group consisting of styrene, alpha-methyl styrene, vinyl chloride, acrylonitrile, methacrylonitrile, ureido methacrylate, vinyl acetate, vinyl esters of branched tertiary monocarboxylic acids, itaconic acid, crotonic acid, maleic acid, fumaric acid, ethylene, and C₄-C₈ conjugated dienes.

The latex polymers used in the compositions according to the invention are preferably film-forming at temperatures about 25° C. or less, either inherently or through the use of plasticizers.

In a particular embodiment of the invention, the latex polymers have a Tg of less than 30° C., more typically less than 20° C., still more typically in the range from 10 to −10° C., e.g., 0° C.

In another particular embodiment of the invention, the latex polymers have a Tg of less than 10° C., more typically less than 5° C., still more typically in the range from 5 to −10° C., e.g., 0° C.

Preferably, the water-based polymer is in the form of particles in dispersion in an aqueous medium.

More preferentially, the water-based polymer is in the form of particles of latex polymer(s) or polyurethane polymer(s) in dispersion in an aqueous medium.

Preferably, the water-based polymer dispersion may comprise from 10 to 70% by weight of water-based polymer(s), more preferentially from 20 to 60% by weight, and even more preferentially from 25 to 55% by weight, relative to the total weight of the water-based polymer dispersion.

Preferably, the water-based polymer dispersion may comprise from 10 to 70% by weight of latex polymer(s), more preferentially from 20 to 60% by weight, and even more preferentially from 25 to 55% by weight, relative to the total weight of the water-based polymer dispersion.

Preferably, the water-based polymer dispersion may comprise from 10 to 70% by weight of polyurethane polymer(s), more preferentially from 20 to 60% by weight, and even more preferentially from 25 to 55% by weight, relative to the total weight of the water-based polymer dispersion.

Advantageously, the composition of the present invention comprises a liquid carrier.

Preferably, the liquid carrier is an aqueous carrier comprising water and optionally at least one water miscible organic liquid.

Suitable water miscible organic liquids include saturated or unsaturated monohydric alcohols and polyhydric alcohols, such as, for example, methanol, ethanol, isopropanol, cetyl alcohol, benzyl alcohol, oleyl alcohol, 2-butoxyethanol, and ethylene glycol, as well as alkylether diols, such as, for example, ethylene glycol monoethyl ether, propylene glycol monoethyl ether and diethylene glycol monomethyl ether.

According to a preferred embodiment of the invention, the composition contains less than 20% by weight of organic solvents, preferably less than 10% by weight, more preferentially less than 5% by weight, and even better less than 1% by weight, relative to the total weight of the composition.

As used herein, terms “aqueous medium” and “aqueous media” are used herein to refer to any liquid medium of which water is a major component. Thus, the term includes water per se as well as aqueous solutions and dispersions.

Preferentially, the composition according to the invention is aqueous.

More preferentially, the water content of the composition ranges from 10% to 90% by weight, and even better from 35% to 85% by weight, even more better from 50 to 80% by weight, relative to the total weight of the composition.

According to a particular embodiment, the composition according to the invention is in the form of an aqueous emulsion.

The pH of the compositions can be adjusted to the desired value by means of basifying agents or acidifying agents. Use may be made, among the basifying agents, of one or more alkaline agents, such as ammonia, sodium hydroxide or ethanolamine. Mention may be made, by way of examples, among the acidifying agents, of inorganic or organic acids, such as hydrochloric acid or orthophosphoric acid.

The composition according to the invention may further contains additives different from the ingredients described previously, such as film-forming aids or coalescing agents (including plasticizers and drying retarders such as high boiling point polar solvents), binders, diluents, absorbents, dispersants different from polymers (i) as described above, disintegration agents, wetting agents, emulsifiers, antifoam agents, antifreeze agents, biocides, mildewcides, dyes, waxes, perfumes, preservatives and/or anti-microbials.

These additives can be present in the composition according to the invention in an amount ranging from 0% to 15% by weight, relative to the total weight of the composition.

A person skilled in the art will be able to choose these optional additives and their amounts so that they do not harm the properties of the compositions of the present invention.

Preferably, the viscosity of an aqueous composition according to the invention, measured at 60 rpm using a Brookfield RV viscometer at 25° C. and at atmospheric pressure (1.013×10⁵ Pa), ranges from 50 mPa·s to 10,000 mPa·s; more preferentially from 100 to 5,000 mPa·s; even more preferentially from 150 to 1,500 mPa·s; better from 200 mPa·s to 1,000 mPa·s; and even better from 250 mPa·s to 800 mPa·s.

According to a preferred embodiment of the invention, the composition comprises:
(i) at least one copolymer obtainable by radical polymerization of:
at least the following monomers:
a) acrylic acid,
b) at least one β-carboxyethyl (meth)acrylate monomer,
c) at least one alkyl (meth)acrylate monomer, said alkyl radical comprising from 1 to 12 carbon atoms,
d) at least one hydrophobic non-acrylic monomer, and
e) at least one (C₁-C₁₂)alkyloxy polyethylene glycol (meth)acrylate monomer,
f) optionally methacrylic acid,
in the presence of a free-radical polymerization initiator; and
(ii) at least one pigment, and
(iii) optionally, at least one water-based polymer;
wherein said copolymer (i) comprises from:
0.1 to 15 mol. % of units from acrylic acid a),
1 to 35 mol. % of units from β-carboxyethyl (meth)acrylate b),
5 to 40 mol. % of units from alkyl (meth)acrylate c),
30 to 60 mol. % of units from hydrophobic non-acrylic monomer d),
1 to 30 mol. % of units from (C₁-C₁₂)alkyloxy polyethylene glycol (meth)acrylate e), and
optionally from 0.1 to 20 mol. % of units from methacrylic acid f).

In said embodiment, the composition is preferably aqueous.

According to another preferred embodiment of the invention, the composition comprises:
(i) at least one copolymer obtainable by radical polymerization of:
at least the following monomers:
a) acrylic acid,
b) at least one β-carboxyethyl (meth)acrylate monomer,
c) at least one alkyl (meth)acrylate monomer, said alkyl radical comprising from 1 to 12 carbon atoms,
d) at least one hydrophobic non-acrylic monomer, and
e) at least one (C₁-C₁₂)alkyloxy polyethylene glycol (meth)acrylate monomer,
f) optionally methacrylic acid,
in the presence of a free-radical polymerization initiator; and
(ii) at least one pigment, and
(iii) optionally, at least one water-based polymer;
wherein said copolymer (i) comprises from:
0.5 to 10 mol. % of units from acrylic acid a),
5 to 30 mol. % of units from β-carboxyethyl (meth)acrylate b),
10 to 30 mol. % of units from alkyl (meth)acrylate c),
35 to 50 mol. % of units from hydrophobic non-acrylic monomer d),
5 to 25 mol. % of units from (C₁-C₁₂)alkyloxy polyethylene glycol (meth)acrylate e), and
optionally from 5 to 20 mol. % of units from methacrylic acid f).

In said embodiment, the composition is preferably aqueous.

According to a more preferentially embodiment of the invention, the composition comprises:
(i) at least one copolymer obtainable by radical polymerization of:
at least the following monomers:
a) acrylic acid,
b) at least one β-carboxyethyl (meth)acrylate monomer of formula (I) as described above,
c) at least one (C₆-C₈)alkyl acrylate monomer,
d) at least one vinyl aromatic monomer, preferably styrene, and
e) at least one (C₁-C₄)alkyloxy polyethylene glycol (meth)acrylate monomer,
f) optionally methacrylic acid,
in the presence of a free-radical polymerization initiator; and
(ii) at least one pigment, and
(iii) optionally, at least one water-based polymer;
wherein said copolymer (i) comprises from:
0.1 to 15 mol. % of units from acrylic acid a),
1 to 35 mol. % of units from β-carboxyethyl (meth)acrylate b) of formula (I),
5 to 40 mol. % of units from (C₆-C₅)alkyl acrylate c),
30 to 60 mol. % of units from vinyl aromatic monomer d),
1 to 30 mol. % of units from (C₁-C₄)alkyloxy polyethylene glycol (meth)acrylate e), and
optionally from 0.1 to 20 mol. % of units from methacrylic acid f).

In said embodiment, the composition is preferably aqueous.

According to an even more preferentially embodiment of the invention, the composition comprises:
(i) at least one copolymer obtainable by controlled radical polymerization of:
at least the following monomers:
a) acrylic acid,
b) at least one β-carboxyethyl (meth)acrylate monomer of formula (I) as described above,
c) at least one (C₆-C₈)alkyl acrylate monomer,
d) at least one vinyl aromatic monomer, preferably styrene, and
e) at least one methoxy polyethylene glycol (meth)acrylate monomer,
f) optionally methacrylic acid, with
a radical polymerization control agent, and
a free-radical polymerization initiator; and
(ii) at least one pigment, and
(iii) optionally, at least one water-based polymer;
wherein said copolymer (i) comprises from:
0.1 to 15 mol. % of units from acrylic acid a),
1 to 35 mol. % of units from β-carboxyethyl (meth)acrylate b) of formula (I),
5 to 40 mol. % of units from (C₆-C₅)alkyl acrylate c),
30 to 60 mol. % of units from vinyl aromatic monomer d),
1 to 30 mol. % of units from methoxy polyethylene glycol (meth)acrylate e), and
optionally from 0.1 to 20 mol. % of units from methacrylic acid f).

In said embodiment, the composition is preferably aqueous.

According to another even more preferentially embodiment of the invention, the composition is aqueous and comprises:
(i) at least one copolymer obtainable by controlled radical polymerization of:
at least the following monomers:
a) acrylic acid,
b) at least one β-carboxyethyl (meth)acrylate monomer of formula (I) as described above,
c) at least one (C₆-C₈)alkyl acrylate monomer,
d) at least one vinyl aromatic monomer, preferably styrene, and
e) at least one methoxy polyethylene glycol (meth)acrylate monomer,
f) optionally methacrylic acid, with
a radical polymerization control agent, and
a free-radical polymerization initiator; and
(ii) at least one pigment, and
(iii) optionally, at least one water-based polymer;
wherein said copolymer (i) comprises from:
0.1 to 15 mol. % of units from acrylic acid a),
1 to 35 mol. % of units from β-carboxyethyl (meth)acrylate b) of formula (I),
5 to 40 mol. % of units from (C₆-C₅)alkyl acrylate c),
30 to 60 mol. % of units from vinyl aromatic monomer d),
1 to 30 mol. % of units from methoxy polyethylene glycol (meth)acrylate e), and
optionally from 0.1 to 20 mol. % of units from methacrylic acid f).

The compositions according to the invention include water-based consumer and industrial paints; sizing, adhesives and other coatings intended to be applied onto the surface of various materials such as for example paper, paperboard, textiles; and the like.

The invention relates to the use of the copolymer (i) as defined previously, as a dispersant in a painting and/or coating composition comprising at least one pigment.

The invention also relates to the use of the copolymer (i) as described previously, as a dispersant in an ink composition comprising at least one pigment.

The invention also relates to a method for treating a material, by applying the composition according to the invention onto the surface of a material.

Among the materials that may be mentioned are, for example, paper, wood, concrete, metal, glass, ceramics, plastics, plaster, and roofing substrates such as asphaltic coatings, roofing felts, foamed polyurethane insulation; or to previously painted, primed, undercoated, worn, or weathered substrates.

The composition of the invention can be applied onto said materials by a variety of techniques well known in the art such as, for example, brush, rollers, mops, air-assisted or airless spray, electrostatic spray, and the like.

According to a particular embodiment of the invention, the method according to the invention is a method for dyeing a material, by applying an ink composition comprising at least one copolymer (i) as described previously and at least one pigment.

In the above description, all the preferred embodiments with regard to the components may be used individually or in combination.

The examples that follow serve to illustrate the invention.

### EXAMPLES

### General Synthesis Procedure:

The copolymers B and D according to the invention were synthetized according to the same process.

The applied process in case of the examples B and D is based on the controlled radical polymerization technology in the presence of the RAFT (Madix) type transfer agent. The applied transfer agent chemistry is the xanthate and the grade used is the Rhodixan A1. The calculation of the quantity of the transfer agent to be used for polymerization is based on the target average number molar mass of the copolymer (equation below)

$$masse ( grams ) Transfer agent = \frac{\sum masse ( grams ) of all monomers * Mw of the transfer agent}{Mn target of the polymer}$$

The target average number molecular mass of the copolymers B, and D is Mn=5000 g/mol.

The whole synthesis is conducted in typical polymerization reactor under nitrogen atmosphere at given temperature and with efficient mechanical agitation system. The polymerization solvent is the mixture of the ethanol and water. In the case of the copolymer D, the methoxypolyethylene glycol (MPEG 750) is also used as a co-solvent.

In a first time (polymerization step), the purged with nitrogen reactor is charged with all monomers, transfer agent and solvents and the reaction medium is heated to 75° C. under stirring. A part (20 wt. % of the overall amount) of the AMBN initiator ((2,2′-Azobis(2-methylbutyronitrile)) solution (20 wt. % in ethanol) is added in one shot to the reaction mixture. The reaction is allowed to react for around 30 min. After this time, the rest of AMBN solution in ethanol is added over the course of around 3 hours by pump. Once the addition is completed, the reaction mixture is let to react for further 10 hours.

In a second time (ethanol removal step), the ethanol is evaporated using a rotatory evaporator, and then water is added to the mixture; the mass of water is the same as the quantity of the ethanol used initially for reaction.

In a third time (neutralization and transfer agent deactivation step) the copolymer solution in water is placed into the reactor, the pH is adjusted to about 7,5 to 8 with sodium hydroxide and heated at 70° C. under stirring. The hydrogen peroxide solution (30 wt. % in water) is added by pump over 1 hour. The reaction is let to react for around 3 hours. A sample is collected for analyses to determine residual monomers, transfer agent and ethanol. A dry extract is measured by gravimetric method. The copolymer solution in water is also tested on pH and viscosity.

According to this procedure several copolymers were synthetized, with different monomer molar ratios and copolymer molar masses.

The particular reagents and their amounts are given in the table below.

Quantities used in grams

| Raw material | Copolymer B | Copolymer D |
|---|---|---|
| Ethanol (solvent) | 337.53 | 268.96 |
| Water (solvent) | 212.47 | 220.21 |
| 2-Ethyl Hexyl Acrylate | 69.50 | 72.03 |
| monomer | | |
| MPEGMA750 monomer | 212.47 | 220.21 |
| MPEG 750 solvent | 0.00 | 60.82 |
| Styrene monomer | 83.48 | 86.52 |
| Methacrylic Acid monomer | 0.00 | 23.07 |
| Sipomer ® BCEA monomers | 61.19 | 24.80 |
| (mixture of acrylic acid | | |
| monomer and | | |
| β-carboxyethyl | | |
| (meth)acrylate monomers of | | |
| formula (I) according to the | | |
| invention) | | |
| Rhodixan A1 transfer agent | 17.07 | 17.07 |
| AMBN initiator | 6.30 | 6.30 |
| Sodium hydroxide | 40.56 | 41.80 |
| (50% in water) | | |
| Hydrogen peroxide (30% in | 29.02 | 29.44 |
| water) | | |

The table below regroups obtained copolymers characteristics.

| | | | Copolymer | |
|---|---|---|---|---|
| Properties | Method | Unit | B | D |
| pH | pH electrode | | 6.3 | 6.8 |
| (at 25° C., solution as is) | | | | |
| Solid Content | Gravimetric | % wt. | 43.7 | 45.1 |
| (115° C.; 30 min; 1 g) | | | | |
| Viscosity (at 25° C.) | Brookfield | cP | 2250 | 190 |
| Residual monomers (total) | HPLC/GC | % | <0.5 | <0.5 |

### Molar Mass Determination

In the present patent application, unless otherwise indicated, when reference is made to molar mass, it will relate to the absolute weight-average molar mass, expressed in g/mol.

Light scattering is an absolute technique, meaning that it does not depend on any calibration standards or calibration curves (M. W. Spears, The Column 12(11), 18-21 (2016)).

The fundamental light scattering equation is:

$$I ( θ ) ∝ M \times c \times {( \frac{d n}{d c} )}^{2} ) \times P ( θ )$$

where the intensity of scattered light at an angle θ is directly proportional to the product of the molar mass M, the concentration c, the square of the specific refractive index increment dn/dc, and an angular factor P(θ), which equals 1 at θ=0. The absolute intensity of scattered light extrapolated to θ=0 is used to calculate molecular weight, and the variance of this intensity with angle is used to calculate the root mean square (rms) radius of the sample.

The mass distribution of the polymer is measured by SEC MALS analysis (SEC: Size Exclusion Chromatography—MALS: Multi-Angle Laser Scattering) in order to obtain the real values, expressed in g/mol.

The SEC MALS analysis is performed with an HPLC chain equipped with 2 detectors:
Differential refractometer RI—the concentration detector
MALS detector (Multi-Angle Laser Scattering)—the mass detector.

The software records the chromatograms of the detectors:
One for the RI detector,
One for each angle of the MALS detector.

For each slice of the chromatograms (for the polymeric species), the software calculates:
The concentration of the polymer, RI signal=constant*dn/dc*concentration
The mass Mi of the slice,

$$M A L S detector = scattered light ∞ constant \times Mi \times {( dn / d c )}^{2} \times concentration$$

From particular Mi data, the software calculates the mass distribution:

$$Mw , Mn and Polydispersity index P D I = Mw / Mn .$$

The calculation of the molar masses requires the refractive index increment, dn/dc of the polymer. It is a constant, depending on the nature of the mobile phase, the temperature of the experimental conditions and the wavelength of the laser among others.

This constant can be measured according to the eluted fraction from the SEC MALS analysis. This constant can be measured with a refractometer. This constant can be found also, for example, in the “Polymer Handbook” or website like www.ampolymer.com/dn-dc.html.

For these copolymers, “dn/dc” is calculated by the software according the mass recovery of the eluted fraction: the dn/dc=0.09 leads from 95 to 100% wt mass recovery.

For these copolymers, the molar mass were calculated based on the real Mi points, without any adjustment of the log(M) curve.

The applied injection amount and Standard sample concentration were as follows: 100 μL, from 2.0 to 2.4 mg/mL (calculated as dry polymer).

Detailed Analysis conditions:
Analysis instrument: Agilent SEC system with MALS detector
Pump: Agilent 1100
Detector: Agilent 1100, Differential Refractometer (RI)
Mobile phase: 100% THF, 0.01 mol/L tetrabutylammonium tetrafluoroborate, 100 μL TFA/1 L THF (TFA: trifluoroacetic acid)
Column: Agilent Polypore (2*30 cm)+guard column
Temperature: 35° C.
Flow rate: 1.0 mL/min
Injection amount and Sample concentration: 100 μL, from 2.0 to 2.4 mg/mL (expressed in dry)
Data processing: ASTRA 7 (Wyatt)

The measured for particular copolymers molar masses were the following:

| | Copolymer Composition, % mol | | | | | | | | |
|---|---|---|---|---|---|---|---|---|---|
| Co- | | | | | | MPEGMA | Mw | | |
| polymer | AA | BCE | MA | St | 2EHA | 750 | (g/mol) | Mn | PDI |
| B | 9 | 13.5 | 0 | 42.5 | 20 | 15 | 14600 | 6700 | 2.2 |
| D | 3.5 | 5.3 | 13.7 | 42.5 | 20 | 15 | 15300 | 7650 | 2.0 |

With AA = acrylic acid; BCE = β-carboxyethyl (meth)acrylate monomers of formula (I) according to the invention; MA = methacrylic acid; St = styrene; 2EHA = 2-ethyl hexyl acrylate; MPEGMA750 = methoxy polyethylene glycol methacrylate.

### Formulation:

The following compositions (B), (D1) and (D2) according to the invention were prepared from the ingredients shown in the tables below, the amounts of which are expressed as weight percentages of active material (AM).

| | Amounts |
|---|---|
| Composition (B) - Ingredients | |
| Copolymer B | 2.7 |
| Titanium dioxide | 1.3 |
| Deionized water | Qs 100 |
| Composition (D1) - Ingredients | |
| Copolymer D | 1.3 |
| Carbon black | 0.6 |
| Deionized water | Qs 100 |
| Composition (D2) - Ingredients | |
| Copolymer D | 30 |
| Raven 5000 Ultra II pigment | 20 |
| Defoamer | 1 |
| Ammonia | 1.6 |
| Deionized water | Qs 100 |

These compositions were prepared as follows: as a starting point, prepare a formulation consisting of pigment, dispersant and deionized water, and defoamer and base (if needed). Liquid ingredients were added, including a small amount of polymeric dispersant as described herein, to the grind pot and mixed at low speeds using a high shear (Cowles) disperser. After a homogeneous mixture has been obtained, pigment was slowly added. Once all of the pigment had been added, mixed at a maximum speed needed to create a strong vortex. After premix finished, attached cooling water, added milling beads and prepared for milling. After 30 minutes milling, waited one minute and measured the viscosity via Brookfield viscometer. Continued to add dispersant incrementally and milled for 4-6 minutes after each addition.

1. A composition for painting and/or coating comprising:
i. at least one copolymer obtainable by radical polymerization of:
at least the following monomers:
a. acrylic acid,
b. at least one β-carboxyethyl (meth)acrylate monomer,
c. at least one alkyl (meth)acrylate monomer, said alkyl radical comprising from 1 to 12 carbon atoms,
d. at least one hydrophobic non-acrylic monomer, and
e. at least one (C₁-C₁₂)alkyloxy polyethylene glycol (meth)acrylate monomer, in the presence of a free-radical polymerization initiator; and
ii. at least one pigment; and
iii. optionally, at least one water-based polymer.

2. The composition according to claim 1, wherein said copolymer (i) comprises from 0.1 to 15 mol. % of units from acrylic acid a).

3. The composition according to claim 1, wherein the β-carboxyethyl (meth)acrylate monomer(s) are of the following formula (I): 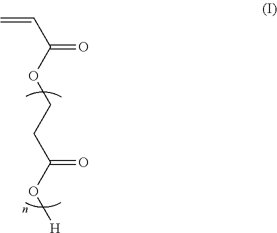
and wherein n is an integer ranging from 1 to 5.

4. The composition according to claim 1, wherein said copolymer (i) comprises from 1 to 35 mol. % of units from β-carboxyethyl (meth)acrylate b).

5. The composition according to claim 1, wherein the (C₁-C₁₂)alkyl (meth)acrylate monomer(s) are chosen from (C₁-C₁₂)alkyl acrylate.

6. The composition according to claim 1, wherein said copolymer (i) comprises from 5 to 40 mol. % of units from alkyl (meth)acrylate c).

7. The composition according to claim 1, wherein the hydrophobic non-acrylic monomer(s) are chosen from vinyl aromatic monomers.

8. The composition according to claim 1, wherein said copolymer (i) comprises from 30 to 60 mol. % of units from hydrophobic non-acrylic monomer d).

9. The composition according to claim 1, wherein said copolymer (i) comprises from 1 to 30 mol. % of units from (C₁-C₁₂)alkyloxy polyethylene glycol (meth)acrylate e).

10. The composition according to claim 1, wherein the monomers used of the polymerization of said copolymer (i) further include a methacrylic acid monomer f); and wherein said copolymer (i) comprises from 0.1 to 20 mol. % of units from methacrylic acid f).

11. The composition according to claim 1, wherein the polydispersity index of said copolymer (i) ranges from 1 to 3,5.

12. The composition according to claim 1, wherein said copolymer (i) is free of unit from strong acid derivatives of (meth)acrylic acid monomers.

13. The composition according to claim 1, wherein the said copolymer (i) has a weight average molecular weight (Mw) less than or equal to 20,000 g/mol.

14. The composition according to claim 1, wherein the said copolymer (i) is obtainable by radical polymerization of:
the following monomers only:
a) acrylic acid,
b) at least one β-carboxyethyl (meth)acrylate monomer,
c) at least one alkyl (meth)acrylate monomer, said alkyl radical comprising from 1 to 12 carbon atoms,
d) at least one hydrophobic non-acrylic monomer,
e) at least one (C₁-C₁₂)alkyloxy polyethylene glycol(meth)acrylate monomer, and
f) optionally methacrylic acid,
in the presence of a free-radical polymerization initiator.

15. The composition according to claim 1, characterized in that the water-based polymer is chosen from latex polymers, polyurethane polymers, and mixtures thereof.

16. The composition according to the preceding claim, characterized in that the water-based polymer is in the form of particles in dispersion in an aqueous medium.

17. The composition according to claim 1, characterized in that the composition is aqueous.

18. A method of dispersing the copolymer (i) as defined in claim 1, as a dispersant in a painting and/or coating composition comprising at least one pigment.

19. A method of dispersing the copolymer (i) as defined in claim 1, as a dispersant in an ink composition comprising at least one pigment.
